(19) United States
(12) Patent Application Publication
(10) Pub. No.: US 2019/0124715 A1
(43) Pub. Date: Apr. 25, 2019

(54) METHOD AND APPARATUS OF PERFORMING MSG3-BASED SYSTEM INFORMATION REQUEST IN A WIRELESS COMMUNICATION SYSTEM

(71) Applicant: ASUSTek Computer Inc., Taipei City 112 (TW)

(72) Inventors: Wei-Yu Chen, Taipei City (TW); Tun-Huai Shih, Taipei City (TW)

(21) Appl. No.: 16/169,343

(22) Filed: Oct. 24, 2018

Related U.S. Application Data
(60) Provisional application No. 62/576,245, filed on Oct. 24, 2017.

(51) Int. Cl. H04W 76/27; H04W 76/11; H04W 74/08; H04W 72/04

(52) U.S. Cl. CPC H04W 76/27; H04W 76/11; H04W 80/02; H04W 72/0413; H04W 74/0866; H04W 74/0833

(57) ABSTRACT

A method and apparatus are disclosed from the perspective of a UE (User Equipment). In one embodiment, the method includes the UE generating a system information request message. The method further includes the UE transmitting the system information request message to a base station through DCCH (Dedicated Control Channel) if the UE is in RRC_CONNECTED state. The method also includes the UE transmitting the system information request message to the base station through CCCH (Common Control Channel) if the UE is not in RRC_CONNECTED state.

### CROSS-REFERENCE TO RELATED APPLICATIONS

The present application claims the benefit of U.S. Provisional Patent Application Ser. No. 62/576,245 filed on Oct. 24, 2017, the entire disclosure of which is incorporated herein in its entirety by reference.

### FIELD

This disclosure generally relates to wireless communication networks, and more particularly, to a method and apparatus of performing Msg3-based system information request in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and apparatus are disclosed from the perspective of a UE (User Equipment). In one embodiment, the method includes the UE generating a system information request message. The method further includes the UE transmitting the system information request message to a base station through DCCH (Dedicated Control Channel) if the UE is in RRC_CONNECTED state. The method also includes the UE transmitting the system information request message to the base station through CCCH (Common Control Channel) if the UE is not in RRC_CONNECTED state.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 4.5.3.1-1 of 3GPP TS 36.321 V14.3.0.

FIG. 6 is a reproduction of Table 4.5.3.1-1 of 3GPP TS 36.321 V14.3.0.

FIG. 7 is a reproduction of FIG. 6.1.3.2-1 of 3GPP TS 36.321 V14.3.0.

FIG. 8 is a reproduction of FIG. 6.1.3.4-1 of 3GPP TS 36.321 V14.3.0.

FIG. 9 is a reproduction of FIG. 6.1.5-1 of 3GPP TS 36.321 V14.3.0.

FIG. 10 is a reproduction of FIG. 6.1.5-2 of 3GPP TS 36.321 V14.3.0.

FIG. 11 is a reproduction of FIG. 6.1.5-3 of 3GPP TS 36.321 V14.3.0.

FIG. 12 is a reproduction of FIG. 6.1.5-3a of 3GPP TS 36.321 V14.3.0.

FIG. 13 is a reproduction of FIG. 6.1.5-3b of 3GPP TS 36.321 V14.3.0.

FIG. 14 is a reproduction of FIGS. 7.3-1 of 3GPP TS 38.300 V1.0.1.

FIG. 15 is a reproduction of FIG. 1 of 3GPP R2-1710096.

FIG. 16 is a diagram according to one exemplary embodiment.

FIG. 17 is a diagram according to one exemplary embodiment.

FIG. 18 is a flow chart according to one exemplary embodiment.

FIG. 19 is a flow chart according to one exemplary embodiment.

FIG. 20 is a flow chart according to one exemplary embodiment.

FIG. 21 is a flow chart according to one exemplary embodiment.

FIG. 22 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including: TR 38.913 V14.1.0, “Study on Scenarios and Requirements for Next Generation Access Technologies”; TS 36.321 V14.3.0, “Evolved Universal Terrestrial Radio Access (E-UTRA); Medium Access Control (MAC) protocol specification”; TR 38.802 V14.1.0, “Study on New Radio Access Technology Physical Layer Aspects”; TS 38.300 V1.0.1, “NR and NG-RAN Overall Description”; R2-1710096, “On Demand SI: Remaining Issues”, Samsung; and TS 36.331 V14.3.0, “Radio Resource Control (RRC); Protocol specification”. The standards and documents listed above are hereby expressly incorporated by reference in their entirety.

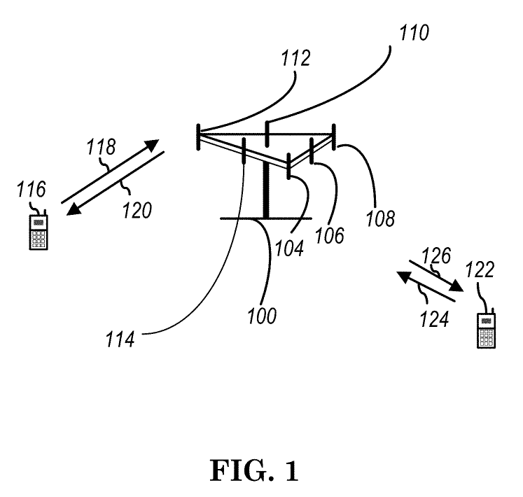

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

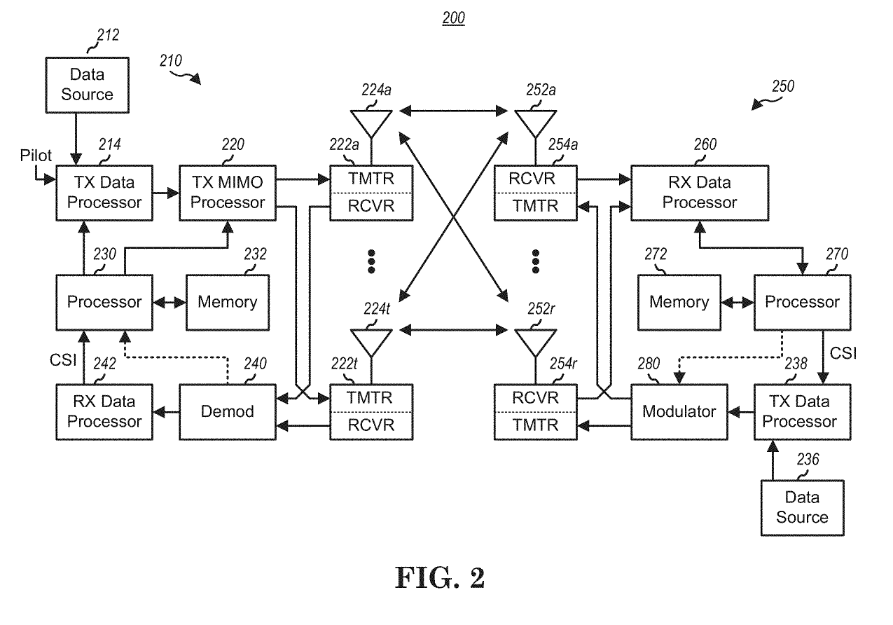

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

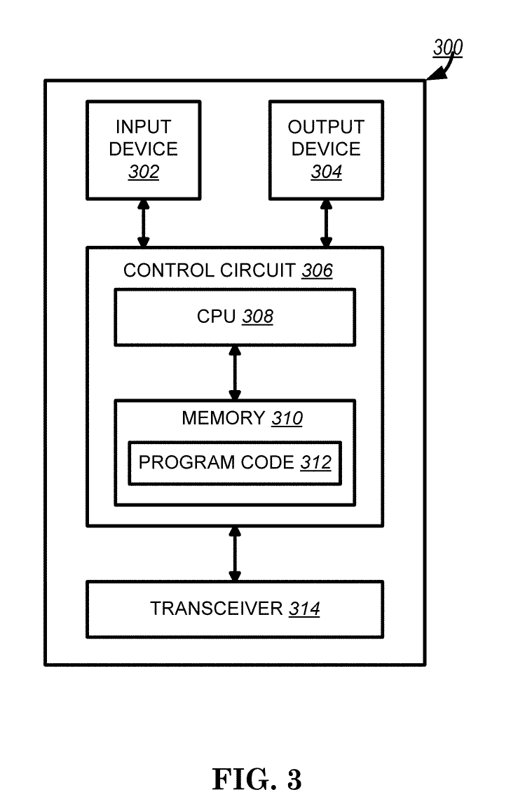

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

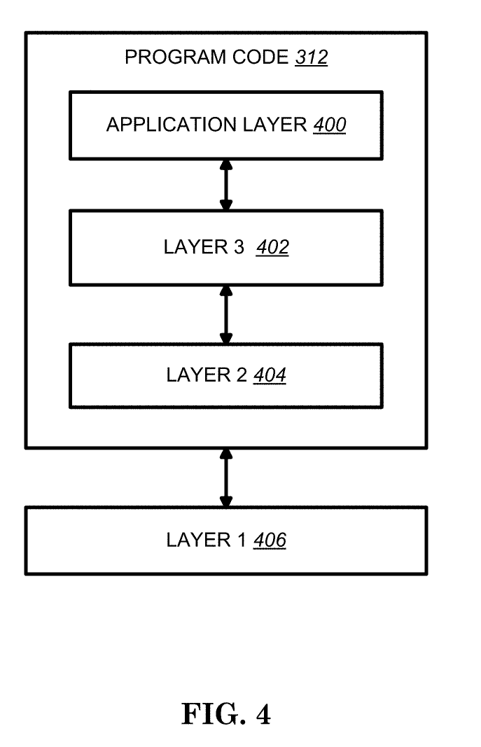

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP standardization activities on next generation (i.e. 5G) access technology have been launched since March 2015. In general, the next generation access technology aims to support the following three families of usage scenarios for satisfying both the urgent market needs and the more long-term requirements set forth by the ITU-R IMT-2020:

eMBB (enhanced Mobile Broadband)

mMTC (massive Machine Type Communications)

URLLC (Ultra-Reliable and Low Latency Communications).

An objective of the 5G study item on new radio access technology is to identify and develop technology components needed for new radio systems which should be able to use any spectrum band ranging at least up to 100 GHz. Supporting carrier frequencies up to 100 GHz brings a number of challenges in the area of radio propagation. As the carrier frequency increases, the path loss also increases.

In LTE, random access, SR (Scheduling Request) and BSR (Buffer Status Report) procedures are defined in 3GPP TS 36.321. The random access procedure, the SR procedure, and the BSR procedure are design for UE to autonomously request uplink resource for data available for transmission in the buffer as follows:

### 4.5.3 Mapping of Transport Channels to Logical Channels

The mapping of logical channels on transport channels depends on the multiplexing that is configured by RRC.

### 4.5.3.1 Uplink Mapping

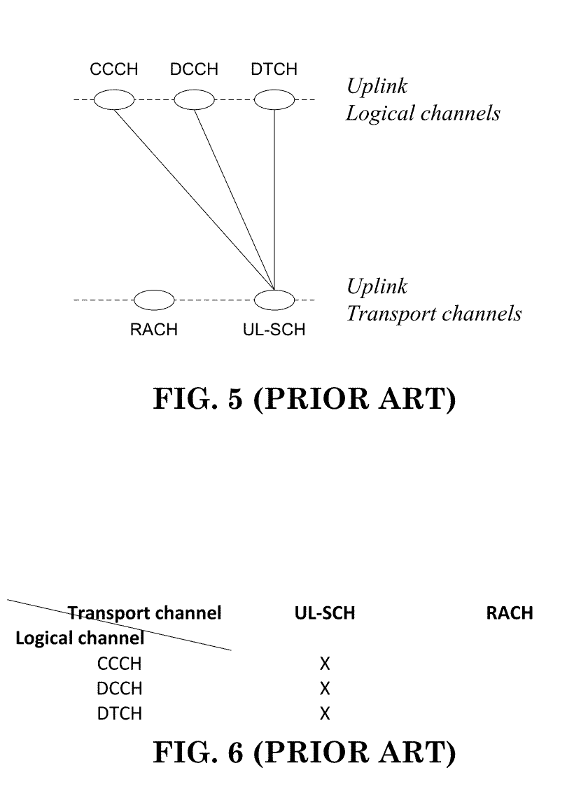

The MAC entity is responsible for mapping logical channels for the uplink onto uplink transport channels. The uplink logical channels can be mapped as described in FIG. 4.5.3.1-1 and Table 4.5.3.1-1.
[FIG. 4.5.3.1-1 of 3GPP TS 36.321 V14.3.0 is reproduced as FIG. 5]
[Table 4.5.3.1-1 of 3GPP TS 36.321 V14.3.0, entitled “Uplink channel mapping”, is reproduced as FIG. 6]
   [ . . . ]

### 5.1 Random Access Procedure

### 5.1.1 Random Access Procedure Initialization

The Random Access procedure described in this subclause is initiated by a PDCCH order, by the MAC sublayer itself or by the RRC sublayer. Random Access procedure on an SCell shall only be initiated by a PDCCH order. If a MAC entity receives a PDCCH transmission consistent with a PDCCH order [5] masked with its C-RNTI, and for a specific Serving Cell, the MAC entity shall initiate a Random Access procedure on this Serving Cell. For Random Access on the SpCell a PDCCH order or RRC optionally indicate the ra-PreambleIndex and the ra-PRACH-MaskIndex, except for NB-IoT where the subcarrier index is indicated; and for Random Access on an SCell, the PDCCH order indicates the ra-PreambleIndex with a value different from 000000 and the ra-PRACH-MaskIndex. For the pTAG preamble transmission on PRACH and reception of a PDCCH order are only supported for SpCell. If the UE is an NB-IoT UE, the Random Access procedure is performed on the anchor carrier or one of the non-anchor carriers for which PRACH resource has been configured in system information.

Before the procedure can be initiated, the following information for related Serving Cell is assumed to be available for UEs other than NB-IoT UEs, BL UEs or UEs in enhanced coverage [8], unless explicitly stated otherwise:
the available set of PRACH resources for the transmission of the Random Access Preamble, prach-Configindex.
the groups of Random Access Preambles and the set of available Random Access Preambles in each group (SpCell only):
The preambles that are contained in Random Access Preambles group A and Random Access Preambles group B are calculated from the parameters numberOfRA-Preambles and sizeOfRA-PreamblesGroupA:

If sizeOfRA-PreamblesGroupA is equal to numberOfRA-Preambles then there is no Random Access Preambles group B. The preambles in Random Access Preamble group A are the preambles 0 to sizeOfRA-PreamblesGroupA−1 and, if it exists, the preambles in Random Access Preamble group B are the preambles sizeOfRA-PreamblesGroupA to numberOfRA-Preambles−1 from the set of 64 preambles as defined in [7].
if Random Access Preambles group B exists, the thresholds, messagePowerOffsetGroupB and messageSizeGroupA, the configured UE transmitted power of the Serving Cell performing the Random Access Procedure, P_{CMAX, c} [10], and the offset between the preamble and Msg3, deltaPreambleMsg3, that are required for selecting one of the two groups of Random Access Preambles (SpCell only).
the RA response window size ra-ResponseWindowSize.
the power-ramping factor powerRampingStep.
the maximum number of preamble transmission preambleTransMax.
the initial preamble power preambleInitialReceivedTargetPower.
the preamble format based offset DELTA_PREAMBLE (see subclause 7.6).
the maximum number of Msg3 HARQ transmissions maxHARQ-Msg3Tx (SpCell only).
the Contention Resolution Timer mac-ContentionResolutionTimer (SpCell only).
   NOTE: The above parameters may be updated from upper layers before each Random Access procedure is initiated.

The following information for related Serving Cell is assumed to be available before the procedure can be initiated for NB-IoT UEs, BL UEs or UEs in enhanced coverage [8]:
if the UE is a BL UE or a UE in enhanced coverage:
   the available set of PRACH resources associated with each enhanced coverage level supported in the Serving Cell for the transmission of the Random Access Preamble, prach-Configindex.
   the groups of Random Access Preambles and the set of available Random Access Preambles in each group (SpCell only):
   If sizeOfRA-PreamblesGroupA is not equal to numberOfRA-Preambles:
      Random Access Preambles group A and B exist and are calculated as above;
   else:
      the preambles that are contained in Random Access Preamble groups for each enhanced coverage level, if it exists, are the preambles firstPreamble to lastPreamble.
         NOTE: When a PRACH resource is shared for multiple CE-levels, and CE-level are differentiated by different preamble indices, Group A and Group B is not used for this PRACH resource.
if the UE is an NB-IoT UE:
   the available set of PRACH resources supported in the Serving Cell on the anchor carrier, nprach-ParametersList, and on the non-anchor carriers, in ul-ConfigList.
   for random access resource selection and preamble transmission:
      a PRACH resource is mapped into an enhanced coverage level.
      each PRACH resource contains a set of nprach-NumSubcarriers subcarriers which can be partitioned into one or two groups for single/multi-tone Msg3 transmission by nprach-SubcarrierMSG3-RangeStart and nproch-NumCBRA-StartSubcarriers as specified in TS 36.211 [7, 10.1.6.1]. Each group is referred to as a Random Access Preamble group below in the procedure text.
      a subcarrier is identified by the subcarrier index in the range: [nprach-SubcarrierOffset, nprach-SubcarrierOffset+nprach-NumSubcarriers−1]
      each subcarrier of a Random Access Preamble group corresponds to a Random Access Preamble.
      when the subcarrier index is explicitly sent from the eNB as part of a PDCCH order ra-PreambleIndex shall be set to the signalled subcarrier index.
   the mapping of the PRACH resources into enhanced coverage levels is determined according to the following:
      the number of enhanced coverage levels is equal to one plus the number of RSRP thresholds present in rsrp-ThresholdsPrachInfoList.
      each enhanced coverage level has one anchor carrier PRACH resource present in nprach-ParametersList and zero or one PRACH resource for each non-anchor carrier signalled in ul-ConfigList.
      enhanced coverage levels are numbered from 0 and the mapping of PRACH resources to enhanced coverage levels are done in increasing numRepetitionsPerPreambleAttempt order.
      when multiple carriers provide PRACH resources for the same enhanced coverage level, the UE will randomly select one of them using the following selection probabilities:
      the selection probability of the anchor carrier PRACH resource for the given enhanced coverage level, nprach-ProbabilityAnchor, is given by the corresponding entry in nprach-ProbabilityAnchorList
      the selection probability is equal for all non-anchor carrier PRACH resources and the probability of selecting one PRACH resource on a given non-anchor carrier is (1−nprach-ProbabilityAnchor)/(number of non-anchor NPRACH resources)
the criteria to select PRACH resources based on RSRP measurement per enhanced coverage level supported in the Serving Cell rsrp-ThresholdsPrachInfoList.
the maximum number of preamble transmission attempts per enhanced coverage level supported in the Serving Cell maxNumPreambleAttemptCE.
the number of repetitions required for preamble transmission per attempt for each enhanced coverage level supported in the Serving Cell numRepetitionPerPreambleAttempt.
the configured UE transmitted power of the Serving Cell performing the Random Access Procedure, P_{CMAX, c} [10].
the RA response window size ra-ResponseWindowSize and the Contention Resolution Timer mac-ContentionResolutionTimer (SpCell only) per enhanced coverage level supported in the Serving Cell.
the power-ramping factor powerRampingStep.
the maximum number of preamble transmission preambleTransMax-CE.
the initial preamble power preambleInitialReceivedTargetPower.
the preamble format based offset DELTA_PREAMBLE (see subclause 7.6). For NB-IoT the DELTA_PREAMBLE is set to 0.

The Random Access procedure shall be performed as follows:
Flush the Msg3 buffer;
set the PREAMBLE_TRANSMISSION_COUNTER to 1;
if the UE is an NB-IoT UE, a BL UE or a UE in enhanced coverage:
   set the PREAMBLE_TRANSMISSION_COUNTER CE to 1;
   if the starting enhanced coverage level, or for NB-IoT the starting number of NPRACH repetitions, has been indicated in the PDCCH order which initiated the Random Access procedure, or if the starting enhanced coverage level has been provided by upper layers:
      the MAC entity considers itself to be in that enhanced coverage level regardless of the measured RSRP;
   else:
      if the RSRP threshold of enhanced coverage level 3 is configured by upper layers in rsrp-ThresholdsPrachInfoList and the measured RSRP is less than the RSRP threshold of enhanced coverage level 3 and the UE is capable of enhanced coverage level 3 then:
      the MAC entity considers to be in enhanced coverage level 3;
      else if the RSRP threshold of enhanced coverage level 2 configured by upper layers in rsrp-ThresholdsPrachInfoList and the measured RSRP is less than the RSRP threshold of enhanced coverage level 2 and the UE is capable of enhanced coverage level 2 then:
      the MAC entity considers to be in enhanced coverage level 2;
      else if the measured RSRP is less than the RSRP threshold of enhanced coverage level 1 as configured by upper layers in rsrp-ThresholdsPrachInfoList then:
      the MAC entity considers to be in enhanced coverage level 1;
      else:
      the MAC entity considers to be in enhanced coverage level 0;
set the backoff parameter value to 0 ms;
for the RN, suspend any RN subframe configuration;
proceed to the selection of the Random Access Resource (see subclause 5.1.2).
   NOTE: There is only one Random Access procedure ongoing at any point in time in a MAC entity. If the MAC entity receives a request for a new Random Access procedure while another is already ongoing in the MAC entity, it is up to UE implementation whether to continue with the ongoing procedure or start with the new procedure.
   NOTE: An NB-IoT UE measures RSRP on the anchor carrier.

### 5.1.2 Random Access Resource Selection

The Random Access Resource selection procedure shall be performed as follows:
For BL UEs or UEs in enhanced coverage, select the PRACH resource set corresponding to the selected enhanced coverage level.
If, except for NB-IoT, ra-PreambleIndex (Random Access Preamble) and ra-PRACH-MaskIndex (PRACH Mask Index) have been explicitly signalled and ra-PreambleIndex is not 000000:
   the Random Access Preamble and the PRACH Mask Index are those explicitly signalled;
else, for NB-IoT, if ra-PreambleIndex (Random Access Preamble) and PRACH resource have been explicitly signalled:
   the PRACH resource is that explicitly signalled;
   if the ra-PreambleIndex signalled is not 000000:
      the Random Access Preamble is set to nprach-SubcarrierOffset+nprach-NumCBRA-StartSubcarriers+(ra-PreambleIndex modulo (nprach-NumSubcarriers-nprach-NumCBRA-StartSubcarriers)), where nprach-SubcarrierOffset, nprach-NumCBRA-StartSubcarriers and nprach-NumSubcarriers are parameters in the currently used PRACH resource.
   else:
      select the Random Access Preamble group according to the PRACH resource and the support for multi-tone Msg3 transmission. A UE supporting multi-tone Msg3 shall only select the single-tone Msg3 Random Access Preambles group if there is no multi-tone Msg3 Random Access Preambles group.
      randomly select a Random Access Preamble within the selected group.
else the Random Access Preamble shall be selected by the MAC entity as follows:
   For BL UEs or UEs in enhanced coverage, if Random Access Preamble group B does not exist, select the Random Access Preambles group corresponding to the selected enhanced coverage level.
   For NB-IoT, randomly select one of the PRACH resources corresponding to the selected enhanced coverage level according to the configured probability distribution, and select the Random Access Preambles group corresponding to the PRACH resource and the support for multi-tone Msg3 transmission. A UE supporting multi-tone Msg3 shall only select the single-tone Msg3 Random Access Preambles group if there is no multi-tone Msg3 Random Access Preambles group.
   Except for BL UEs or UEs in enhanced coverage in case preamble group B does not exist, or except for NB-IoT UEs, if Msg3 has not yet been transmitted, the MAC entity shall:
      if Random Access Preambles group B exists and any of the following events occur:
      the potential message size (UL data available for transmission plus MAC header and, where required, MAC control elements) is greater than messageSizeGroupA and the pathloss is less than P_{CMAX,c} (of the Serving Cell performing the Random Access Procedure)-preambleInitialReceivedTargetPower-deltaPreambleMsg3-messagePowerOffsetGroupB;
      the Random Access procedure was initiated for the CCCH logical channel and the CCCH SDU size plus MAC header is greater than messageSizeGroupA;
         select the Random Access Preambles group B;
      else:
      select the Random Access Preambles group A.
   else, if Msg3 is being retransmitted, the MAC entity shall:
      select the same group of Random Access Preambles as was used for the preamble transmission attempt corresponding to the first transmission of Msg3.
   randomly select a Random Access Preamble within the selected group. The random function shall be such that each of the allowed selections can be chosen with equal probability;
   except for NB-IoT, set PRACH Mask Index to 0.
determine the next available subframe containing PRACH permitted by the restrictions given by the prach-Configindex (except for NB-IoT), the PRACH Mask Index (except for NB-IoT, see subclause 7.3), physical layer timing requirements [2] and in case of NB-IoT, the subframes occupied by PRACH resources related to a higher enhanced coverage level (a MAC entity may take into account the possible occurrence of measurement gaps when determining the next available PRACH subframe);
if the transmission mode is TDD and the PRACH Mask Index is equal to zero:
   if ra-PreambleIndex was explicitly signalled and it was not 000000 (i.e., not selected by MAC):
      randomly select, with equal probability, one PRACH from the PRACHs available in the determined subframe.
   else:
      randomly select, with equal probability, one PRACH from the PRACHs available in the determined subframe and the next two consecutive subframes.
else:
   determine a PRACH within the determined subframe in accordance with the requirements of the PRACH Mask Index, if any.
for NB-IoT UEs, BL UEs or UEs in enhanced coverage, select the ra-ResponseWindowSize and mac-ContentionResolutionTimer corresponding to the selected enhanced coverage level and PRACH.
proceed to the transmission of the Random Access Preamble (see subclause 5.1.3).

### 5.1.3 Random Access Preamble Transmission

The random-access procedure shall be performed as follows:
set PREAMBLE_RECEIVED_TARGET_POWER to preambleInitialReceivedTargetPower+DELTA_PREAMBLE+(PREAMBLE_TRANSMISSION_COUNTER−1)*powerRampingStep;
if the UE is a BL UE or a UE in enhanced coverage:
   the PREAMBLE_RECEIVED_TARGET_POWER is set to:
   PREAMBLE_RECEIVED_TARGET_POWER−10*log 10(numRepetitionPerPreambleAttempt);
if NB-IoT:
   for enhanced coverage level 0, the PREAMBLE_RECEIVED_TARGET_POWER is set to:
   PREAMBLE_RECEIVED_TARGET_POWER−10*log 10(numRepetitionPerPreambleAttempt)
   for other enhanced coverage levels, the PREAMBLE_RECEIVED_TARGET_POWER is set corresponding to the max UE output power;
if the UE is an NB-IoT UE, a BL UE or a UE in enhanced coverage:
   instruct the physical layer to transmit a preamble with the number of repetitions required for preamble transmission corresponding to the selected preamble group (i.e., numRepetitionPerPreambleAttempt) using the selected PRACH corresponding to the selected enhanced coverage level, corresponding RA-RNTI, preamble index or for NB-IoT subcarrier index, and PREAMBLE_RECEIVED_TARGET_POWER.
else:
   instruct the physical layer to transmit a preamble using the selected PRACH, corresponding RA-RNTI, preamble index and PREAMBLE_RECEIVED_TARGET_POWER.

### 5.1.4 Random Access Response Reception

Once the Random Access Preamble is transmitted and regardless of the possible occurrence of a measurement gap or a Sidelink Discovery Gap for Transmission or a Sidelink Discovery Gap for Reception, the MAC entity shall monitor the PDCCH of the SpCell for Random Access Response(s) identified by the RA-RNTI defined below, in the RA Response window which starts at the subframe that contains the end of the preamble transmission [7] plus three subframes and has length ra-ResponseWindowSize. If the UE is a BL UE or a UE in enhanced coverage, RA Response window starts at the subframe that contains the end of the last preamble repetition plus three subframes and has length ra-ResponseWindowSize for the corresponding coverage level. If the UE is an NB-IoT UE, in case the number of NPRACH repetitions is greater than or equal to 64, RA Response window starts at the subframe that contains the end of the last preamble repetition plus 41 subframes and has length ra-ResponseWindowSize for the corresponding coverage level, and in case the number of NPRACH repetitions is less than 64, RA Response window starts at the subframe that contains the end of the last preamble repetition plus 4 subframes and has length ra-ResponseWindowSize for the corresponding coverage level. The RA-RNTI associated with the PRACH in which the Random Access Preamble is transmitted, is computed as:

RA-RNTI=1+t_id+10*f_id

where t_id is the index of the first subframe of the specified PRACH (0≤t_id<10), and f_id is the index of the specified PRACH within that subframe, in ascending order of frequency domain (0≤f_id<6) except for NB-IoT UEs, BL UEs or UEs in enhanced coverage. If the PRACH resource is on a TDD carrier, the f_id is set to f_{RA}, where f_{RA} is defined in Section 5.7.1 of [7].

For BL UEs and UEs in enhanced coverage, RA-RNTI associated with the PRACH in which the Random Access Preamble is transmitted, is computed as:

RA-RNTI=1+t_id+10*f_id+60*(SFN_id mod(W max/10))

where t_id is the index of the first subframe of the specified PRACH (0≤t_id<10), f_id is the index of the specified PRACH within that subframe, in ascending order of frequency domain (0≤f_id<6), SFN_id is the index of the first radio frame of the specified PRACH, and Wmax is 400, maximum possible RAR window size in subframes for BL UEs or UEs in enhanced coverage. If the PRACH resource is on a TDD carrier, the f_id is set to f_{RA}, where f_{RA} is defined in Section 5.7.1 of [7].

For NB-IoT UEs, the RA-RNTI associated with the PRACH in which the Random Access Preamble is transmitted, is computed as:

RA-RNTI=1+floor(SFN_id/4)+256*carrier_id

where SFN_id is the index of the first radio frame of the specified PRACH and carrier_id is the index of the UL carrier associated with the specified PRACH. The carrier_id of the anchor carrier is 0.

The MAC entity may stop monitoring for Random Access Response(s) after successful reception of a Random Access Response containing Random Access Preamble identifiers that matches the transmitted Random Access Preamble.
If a downlink assignment for this TTI has been received on the PDCCH for the RA-RNTI and the received TB is successfully decoded, the MAC entity shall regardless of the possible occurrence of a measurement gap or a Sidelink Discovery Gap for Transmission or a Sidelink Discovery Gap for Reception:
   if the Random Access Response contains a Backoff Indicator subheader:
      set the backoff parameter value as indicated by the BI field of the Backoff Indicator subheader and Table 7.2-1, except for NB-IoT where the value from Table 7.2-2 is used.
   else, set the backoff parameter value to 0 ms.
   if the Random Access Response contains a Random Access Preamble identifier corresponding to the transmitted Random Access Preamble (see subclause 5.1.3), the MAC entity shall:
      consider this Random Access Response reception successful and apply the following actions for the serving cell where the Random Access Preamble was transmitted:
      process the received Timing Advance Command (see subclause 5.2);
      indicate the preambleInitialReceivedTargetPower and the amount of power ramping applied to the latest preamble transmission to lower layers (i.e., (PREAMBLE_TRANSMISSION_COUNTER−1)*powerRampingStep);
      if the SCell is configured with ul-Configuration-r14, ignore the received UL grant otherwise process the received UL grant value and indicate it to the lower layers;
      if ra-PreambleIndex was explicitly signalled and it was not 000000 (i.e., not selected by MAC):
      consider the Random Access procedure successfully completed.
      if the UE is an NB-IoT UE:
         the UL grant contained in the PDCCH transmission is valid only for the configured carrier.
      else, if the Random Access Preamble was selected by the MAC entity:
      set the Temporary C-RNTI to the value received in the Random Access Response message no later than at the time of the first transmission corresponding to the UL grant provided in the Random Access Response message;
      if this is the first successfully received Random Access Response within this Random Access procedure:
         if the transmission is not being made for the CCCH logical channel, indicate to the Multiplexing and assembly entity to include a C-RNTI MAC control element in the subsequent uplink transmission;
         obtain the MAC PDU to transmit from the “Multiplexing and assembly” entity and store it in the Msg3 buffer.
         NOTE: When an uplink transmission is required, e.g., for contention resolution, the eNB should not provide a grant smaller than 56 bits (or 88 bits for NB-IoT) in the Random Access Response.
         NOTE: If within a Random Access procedure, an uplink grant provided in the Random Access Response for the same group of Random Access Preambles has a different size than the first uplink grant allocated during that Random Access procedure, the UE behavior is not defined.

If no Random Access Response or, for BL UEs or UEs in enhanced coverage for mode B operation, no PDCCH scheduling Random Access Response is received within the RA Response window, or if none of all received Random Access Responses contains a Random Access Preamble identifier corresponding to the transmitted Random Access Preamble, the Random Access Response reception is considered not successful and the MAC entity shall:
if the notification of power ramping suspension has not been received from lower layers:
   increment PREAMBLE_TRANSMISSION_COUNTER by 1;
if the UE is an NB-IoT UE, a BL UE or a UE in enhanced coverage:
   if PREAMBLE_TRANSMISSION_COUNTER=preambleTransMax-CE+1:
      if the Random Access Preamble is transmitted on the SpCell:
      indicate a Random Access problem to upper layers;
      if NB-IoT:
         consider the Random Access procedure unsuccessfully completed;
else:
   if PREAMBLE_TRANSMISSION_COUNTER=preambleTransMax+1:
      if the Random Access Preamble is transmitted on the SpCell:
      indicate a Random Access problem to upper layers;
      if the Random Access Preamble is transmitted on an SCell:
      consider the Random Access procedure unsuccessfully completed.
if in this Random Access procedure, the Random Access Preamble was selected by MAC:
   based on the backoff parameter, select a random backoff time according to a uniform distribution between 0 and the Backoff Parameter Value;
   delay the subsequent Random Access transmission by the backoff time;
else if the SCell where the Random Access Preamble was transmitted is configured with ul-Configuration-r14:
   delay the subsequent Random Access transmission until the Random Access Procedure is initiated by a PDCCH order with the same ra-PreambleIndex and ra-PRACH-MaskIndex;
if the UE is an NB-IoT UE, a BL UE or a UE in enhanced coverage:
   increment PREAMBLE_TRANSMISSION_COUNTER CE by 1;
   if PREAMBLE_TRANSMISSION_COUNTER CE=maxNumPreambleAttemptCE for the corresponding enhanced coverage level+1:
      reset PREAMBLE_TRANSMISSION_COUNTER_CE;
      consider to be in the next enhanced coverage level, if it is supported by the Serving Cell and the UE, otherwise stay in the current enhanced coverage level;
      if the UE is an NB-IoT UE:
      if the Random Access Procedure was initiated by a PDCCH order:
         select the PRACH resource in the list of UL carriers providing a PRACH resource for the selected enhanced coverage level for which the carrier index is equal to ((Carrier Index from the PDCCH order) modulo (Number of PRACH resources in the selected enhanced coverage));
         consider the selected PRACH resource as explicitly signalled;
proceed to the selection of a Random Access Resource (see subclause 5.1.2).

### 5.1.5 Contention Resolution

Contention Resolution is based on either C-RNTI on PDCCH of the SpCell or UE Contention Resolution Identity on DL-SCH.

Once Msg3 is transmitted, the MAC entity shall:
except for a BL UE or a UE in enhanced coverage, or an NB-IoT UE, start mac-ContentionResolutionTimer and restart mac-ContentionResolutionTimer at each HARQ retransmission;
for a BL UE or a UE in enhanced coverage, or an NB-IoT UE, start mac-ContentionResolutionTimer and restart mac-ContentionResolutionTimer at each HARQ retransmission of the bundle in the subframe containing the last repetition of the corresponding PUSCH transmission;
regardless of the possible occurrence of a measurement gap or Sidelink Discovery Gap for Reception, monitor the PDCCH until mac-ContentionResolutionTimer expires or is stopped;
if notification of a reception of a PDCCH transmission is received from lower layers, the MAC entity shall:
   if the C-RNTI MAC control element was included in Msg3:
      if the Random Access procedure was initiated by the MAC sublayer itself or by the RRC sublayer and the PDCCH transmission is addressed to the C-RNTI and contains an UL grant for a new transmission; or
      if the Random Access procedure was initiated by a PDCCH order and the PDCCH transmission is addressed to the C-RNTI:
      consider this Contention Resolution successful;
      stop mac-ContentionResolutionTimer;
      discard the Temporary C-RNTI;
      if the UE is an NB-IoT UE:
         the UL grant or DL assignment contained in the PDCCH transmission is valid only for the configured carrier.
      consider this Random Access procedure successfully completed.
   else if the CCCH SDU was included in Msg3 and the PDCCH transmission is addressed to its Temporary C-RNTI:
      if the MAC PDU is successfully decoded:
      stop mac-ContentionResolutionTimer;
      if the MAC PDU contains a UE Contention Resolution Identity MAC control element; and
      if the UE Contention Resolution Identity included in the MAC control element matches the 48 first bits of the CCCH SDU transmitted in Msg3:
         consider this Contention Resolution successful and finish the disassembly and demultiplexing of the MAC PDU;
         set the C-RNTI to the value of the Temporary C-RNTI;
         discard the Temporary C-RNTI;
         consider this Random Access procedure successfully completed.
      else
         discard the Temporary C-RNTI;
         consider this Contention Resolution not successful and discard the successfully decoded MAC PDU.
if mac-ContentionResolutionTimer expires:
   discard the Temporary C-RNTI;
   consider the Contention Resolution not successful.
if the Contention Resolution is considered not successful the MAC entity shall:
   flush the HARQ buffer used for transmission of the MAC PDU in the Msg3 buffer;
   if the notification of power ramping suspension has not been received from lower layers:
      increment PREAMBLE_TRANSMISSION_COUNTER by 1;
   if the UE is an NB-IoT UE, a BL UE or a UE in enhanced coverage:
      if PREAMBLE_TRANSMISSION_COUNTER=preambleTransMax-CE+1:
      indicate a Random Access problem to upper layers.
      if NB-IoT:
         consider the Random Access procedure unsuccessfully completed;
   else:
      if PREAMBLE_TRANSMISSION_COUNTER=preambleTransMax+1:
      indicate a Random Access problem to upper layers.
   based on the backoff parameter, select a random backoff time according to a uniform distribution between 0 and the Backoff Parameter Value;
   delay the subsequent Random Access transmission by the backoff time;
   proceed to the selection of a Random Access Resource (see subclause 5.1.2).

### 5.1.6 Completion of the Random Access Procedure

At completion of the Random Access procedure, the MAC entity shall:
discard explicitly signalled ra-PreambleIndex and ra-PRACH-MaskIndex, if any;
flush the HARQ buffer used for transmission of the MAC PDU in the Msg3 buffer.

In addition, the RN shall resume the suspended RN subframe configuration, if any.

[ . . . ]

### 5.4.3.1 Logical Channel Prioritization

The Logical Channel Prioritization procedure is applied when a new transmission is performed. RRC controls the scheduling of uplink data by signalling for each logical channel: priority where an increasing priority value indicates a lower priority level, prioritisedBitRate which sets the Prioritized Bit Rate (PBR), bucketSizeDuration which sets the Bucket Size Duration (BSD). For NB-IoT, prioritisedBitRate, bucketSizeDuration and the corresponding steps of the Logical Channel Prioritisation procedure (i.e., Step 1 and Step 2 below) are not applicable. The MAC entity shall maintain a variable Bj for each logical channel j. Bj shall be initialized to zero when the related logical channel is established, and incremented by the product PBR×TTI duration for each TTI, where PBR is Prioritized Bit Rate of logical channel j. However, the value of Bj can never exceed the bucket size and if the value of Bj is larger than the bucket size of logical channel j, it shall be set to the bucket size. The bucket size of a logical channel is equal to PBR×BSD, where PBR and BSD are configured by upper layers.

The MAC entity shall perform the following Logical Channel Prioritization procedure when a new transmission is performed:
The MAC entity shall allocate resources to the logical channels in the following steps:
   Step 1: All the logical channels with Bj>0 are allocated resources in a decreasing priority order. If the PBR of a logical channel is set to “infinity”, the MAC entity shall allocate resources for all the data that is available for transmission on the logical channel before meeting the PBR of the lower priority logical channel(s);
   Step 2: the MAC entity shall decrement Bj by the total size of MAC SDUs served to logical channel j in Step 1;
NOTE: The value of Bj can be negative.
   Step 3: if any resources remain, all the logical channels are served in a strict decreasing priority order (regardless of the value of Bj) until either the data for that logical channel or the UL grant is exhausted, whichever comes first. Logical channels configured with equal priority should be served equally.
The UE shall also follow the rules below during the scheduling procedures above:
   the UE should not segment an RLC SDU (or partially transmitted SDU or retransmitted RLC PDU) if the whole SDU (or partially transmitted SDU or retransmitted RLC PDU) fits into the remaining resources of the associated MAC entity;
   if the UE segments an RLC SDU from the logical channel, it shall maximize the size of the segment to fill the grant of the associated MAC entity as much as possible;
   the UE should maximise the transmission of data.
   if the MAC entity is given an UL grant size that is equal to or larger than 4 bytes while having data available for transmission, the MAC entity shall not transmit only padding BSR and/or padding (unless the UL grant size is less than 7 bytes and an AMD PDU segment needs to be transmitted);
   for transmissions on serving cells operating according to Frame Structure Type 3, the MAC entity shall only consider logical channels for which Iaa-Allowed has been configured.

The MAC entity shall not transmit data for a logical channel corresponding to a radio bearer that is suspended (the conditions for when a radio bearer is considered suspended are defined in [8]).

If the MAC PDU includes only the MAC CE for padding BSR or periodic BSR with zero MAC SDUs and there is no aperiodic CSI requested for this TTI [2], the MAC entity shall not generate a MAC PDU for the HARQ entity in the following cases:
in case the MAC entity is configured with skipUplinkTxDynamic and the grant indicated to the HARQ entity was addressed to a C-RNTI; or
in case the MAC entity is configured with skipUplinkTxSPS and the grant indicated to the HARQ entity is a configured uplink grant;

For the Logical Channel Prioritization procedure, the MAC entity shall take into account the following relative priority in decreasing order:
MAC control element for C-RNTI or data from UL-CCCH;
MAC control element for DPR;
MAC control element for SPS confirmation;
MAC control element for BSR, with exception of BSR included for padding;
MAC control element for PHR, Extended PHR, or Dual Connectivity PHR;
MAC control element for Sidelink BSR, with exception of Sidelink BSR included for padding;
data from any Logical Channel, except data from UL-CCCH;
MAC control element for Recommended bit rate query;
MAC control element for BSR included for padding;
MAC control element for Sidelink BSR included for padding.
NOTE: When the MAC entity is requested to transmit multiple MAC PDUs in one TTI, steps 1 to 3 and the associated rules may be applied either to each grant independently or to the sum of the capacities of the grants. Also the order in which the grants are processed is left up to UE implementation. It is up to the UE implementation to decide in which MAC PDU a MAC control element is included when MAC entity is requested to transmit multiple MAC PDUs in one TTI. When the UE is requested to generate MAC PDU(s) in two MAC entities in one TTI, it is up to UE implementation in which order the grants are processed.
   [ . . . ]

### 5.4.4 Scheduling Request

The Scheduling Request (SR) is used for requesting UL-SCH resources for new transmission.

When an SR is triggered, it shall be considered as pending until it is cancelled. All pending SR(s) shall be cancelled and sr-ProhibitTimer shall be stopped when a MAC PDU is assembled and this PDU includes a BSR which contains buffer status up to (and including) the last event that triggered a BSR (see subclause 5.4.5), or, if all pending SR(s) are triggered by Sidelink BSR, when a MAC PDU is assembled and this PDU includes a Sidelink BSR which contains buffer status up to (and including) the last event that triggered a Sidelink BSR (see subclause 5.14.1.4), or, if all pending SR(s) are triggered by Sidelink BSR, when upper layers configure autonomous resource selection, or when the UL grant(s) can accommodate all pending data available for transmission.

If an SR is triggered and there is no other SR pending, the MAC entity shall set the SR_COUNTER to 0.

As long as one SR is pending, the MAC entity shall for each TTI:
if no UL-SCH resources are available for a transmission in this TTI:
   if the MAC entity has no valid PUCCH resource for SR configured in any TTI and if rach-Skip for the MCG MAC entity or rach-SkipSCG for the SCG MAC entity is not configured: initiate a Random Access procedure (see subclause 5.1) on the SpCell and cancel all pending SRs;
   else if the MAC entity has at least one valid PUCCH resource for SR configured for this TTI and if this TTI is not part of a measurement gap or Sidelink Discovery Gap for Transmission and if sr-ProhibitTimer is not running:
      if SR COUNTER<dsr-TransMax:
      increment SR_COUNTER by 1;
      instruct the physical layer to signal the SR on one valid PUCCH resource for SR;
      start the sr-ProhibitTimer.
      else:
      notify RRC to release PUCCH for all serving cells;
      notify RRC to release SRS for all serving cells;
      clear any configured downlink assignments and uplink grants;
      initiate a Random Access procedure (see subclause 5.1) on the SpCell and cancel all pending SRs.
         NOTE: The selection of which valid PUCCH resource for SR to signal SR on when the MAC entity has more than one valid PUCCH resource for SR in one TTI is left to UE implementation.
         NOTE: SR COUNTER is incremented for each SR bundle. sr-ProhibitTimer is started in the first TTI of an SR bundle.

### 6.1.3.2 C-RNTI MAC Control Element

The C-RNTI MAC control element is identified by MAC PDU subheader with LCID as specified in table 6.2.1-2.

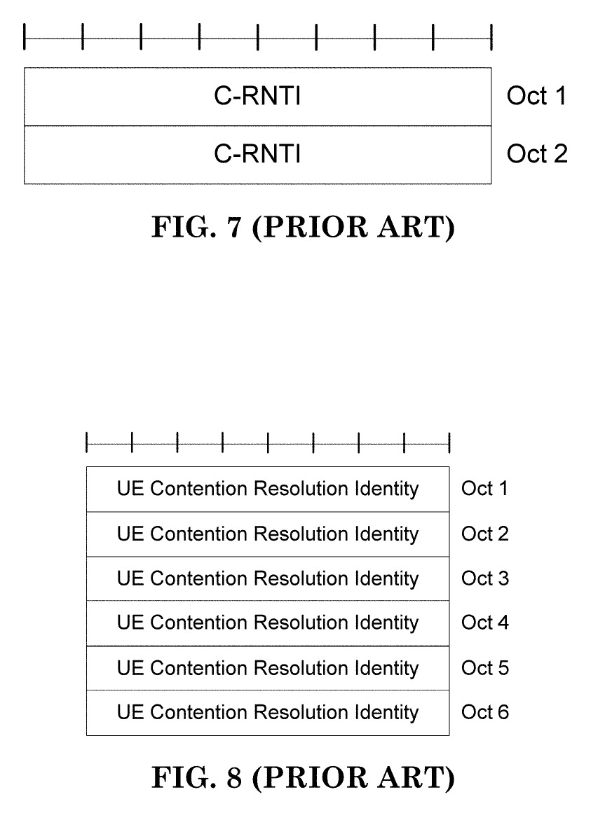

It has a fixed size and consists of a single field defined as follows (FIG. 6.1.3.2-1):
C-RNTI: This field contains the C-RNTI of the MAC entity. The length of the field is 16 bits.
[FIG. 6.1.3.2-1 of 3GPP TS 36.321 V14.3.0, entitled “C-RNTI MAC control element”, is reproduced as FIG. 7]
   [ . . . ]

### 6.1.3.4 UE Contention Resolution Identity MAC Control Element

The UE Contention Resolution Identity MAC control element is identified by MAC PDU subheader with LCID as specified in table 6.2.1-1. This control element has a fixed 48-bit size and consists of a single field defined as follows (FIG. 6.1.3.4-1)
UE Contention Resolution Identity: If this MAC control element is included in response to an uplink CCCH transmission, then this field contains the uplink CCCH SDU if the uplink CCCH SDU is 48 bits long. If the CCCH SDU is longer than 48 bits, this field contains the first 48 bits of the uplink CCCH SDU. If this MAC control element is included in response to an uplink DCCH transmission (i.e. the MAC entity is configured with rach-Skip or rach-SkipSCG), then the MAC entity shall ignore the contents of this field.
[FIG. 6.1.3.4-1 of 3GPP TS 36.321 V14.3.0, entitled “UE Contention Resolution Identity MAC control element”, is reproduced as FIG. 8]
   [ . . . ]

### 6.1.5 MAC PDU (Random Access Response)

A MAC PDU consists of a MAC header and zero or more MAC Random Access Responses (MAC RAR) and optionally padding as described in FIG. 6.1.5-4.

The MAC header is of variable size.

A MAC PDU header consists of one or more MAC PDU subheaders; each subheader corresponding to a MAC RAR except for the Backoff Indicator subheader. If included, the Backoff Indicator subheader is only included once and is the first subheader included within the MAC PDU header.

A MAC PDU subheader consists of the three header fields E/T/RAPID (as described in FIG. 6.1.5-1) but for the Backoff Indicator subheader which consists of the five header field E/T/R/R/BI (as described in FIG. 6.1.5-2).

A MAC RAR consists of the four fields R/Timing Advance Command/UL Grant/Temporary C-RNTI (as described in FIGS. 6.1.5-3, 6.1.5-3a and 6.1.5-3b). For BL UEs and UEs in enhanced coverage in enhanced coverage level 2 or 3 (see subclause 6.2 in [2]) the MAC RAR in FIG. 6.1.5-3a is used, for NB-IoT UEs (see subclause 16.3.3 in [2]) the MAC RAR in FIG. 6.1.5-3b is used, otherwise the MAC RAR in FIG. 6.1.5-3 is used.

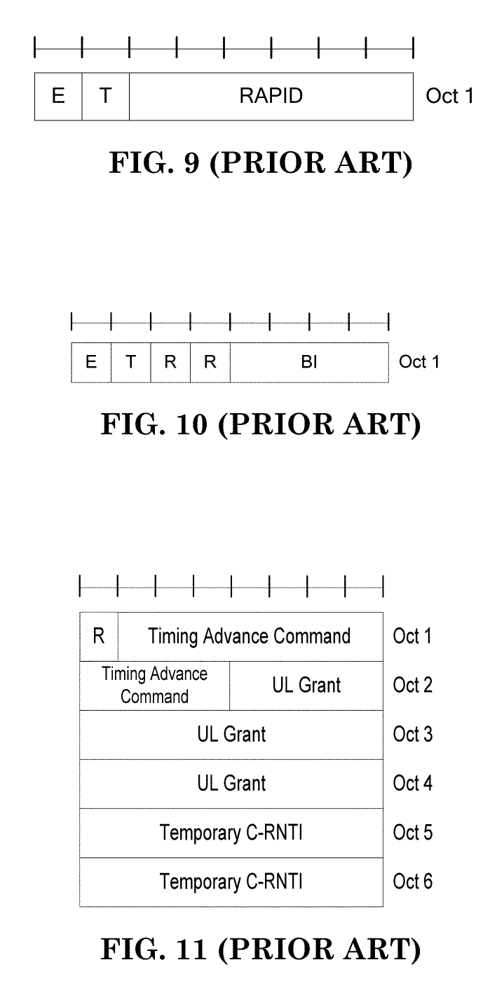

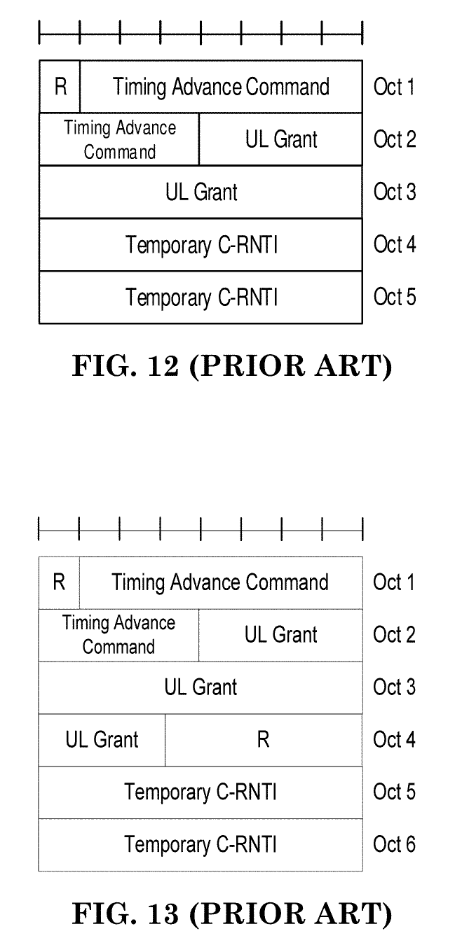

Padding may occur after the last MAC RAR. Presence and length of padding is implicit based on TB size, size of MAC header and number of RARs.
[FIG. 6.1.5-1 of 3GPP TS 36.321 V14.3.0, entitled “E/T/RAPID MAC subheader”, is reproduced as FIG. 9]
[FIG. 6.1.5-2 of 3GPP TS 36.321 V14.3.0, entitled “E/T/R/R/BI MAC subheader”, is reproduced as FIG. 10]
[FIG. 6.1.5-3 of 3GPP TS 36.321 V14.3.0, entitled “MAC RAR”, is reproduced as FIG. 11]
[FIG. 6.1.5-3a of 3GPP TS 36.321 V14.3.0, entitled “MAC RAR for PRACH enhanced coverage level 2 or 3”, is reproduced as FIG. 12]
[FIG. 6.1.5-3b of 3GPP TS 36.321 V14.3.0, entitled “MAC RAR for NB-IoT UEs”, is reproduced as FIG. 13]

3GPP TS 38.300 captures agreements related to system information request and agreements of UE states as follows:

### 7.2 Protocol States

RRC supports the following states which can be characterised as follows:
RRC_IDLE:
   PLMN selection;
   Broadcast of system information;
   Cell re-selection mobility;
   Paging for mobile terminated data is initiated by 5GC;
   Paging for mobile terminated data area is managed by 5GC;
   DRX for CN paging configured by NAS.

FFS whether the UE AS context is not stored in any gNB or in the UE.
RRC_INACTIVE:
   Broadcast of system information;
   Cell re-selection mobility;
   Paging is initiated by NG-RAN (RAN paging);
   RAN-based notification area (RNA) is managed by NG-RAN;
   DRX for RAN paging configured by NG-RAN;
   5GC-NG-RAN connection (both C/U-planes) is established for UE;
   The UE AS context is stored in at least one gNB and the UE;
   NG-RAN knows the RNA which the UE belongs to.

FFS if data transmission in possible in INACTIVE. FFS if PLMN selection is supported in INACTIVE.
RRC_CONNECTED:
   The UE has an NG-RAN RRC connection;
   5GC-NG-RAN connection (both C/U-planes) is established for UE;
   The UE has an AS context in NG-RAN;
   NG-RAN knows the cell which the UE belongs to;
   Transfer of unicast data to/from the UE;
   Network controlled mobility including measurements.

### 7.3 System Information Handling

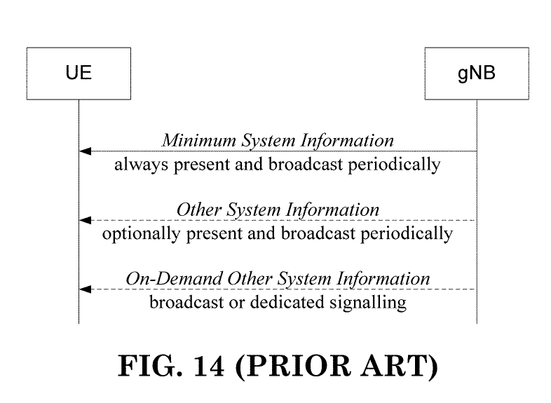

System Information (SI) is divided into Minimum SI and Other SI. Minimum SI is periodically broadcast and comprises basic information required for initial access and information for acquiring any other SI broadcast periodically or provisioned on-demand, i.e. scheduling information. The Other SI encompasses everything not broadcast in the Minimum SI and may either be broadcast, or provisioned in a dedicated manner, either triggered by the network or upon request from the UE as illustrated in FIGS. 7.3-1 below.
[FIGS. 7.3-1 of 3GPP TS 38.300 V1.0.1, entitled “System Information Provisioning”, is reproduced as FIG. 14]

### Exact Names Pending Stage 3 Agreements.

For UEs in RRC_CONNECTED, dedicated RRC signalling is used for the request and delivery of the Other SI. For UEs in RRC_{—} IDLE and RRC_INACTIVE, the request triggers a random access procedure (see subclause 9.2.6) and is carried over MSG3 unless the requested SI is associated to a subset of the PRACH resources, in which case MSG1 can be used. When MSG1 is used, the minimum granularity of the request is one SI message (i.e. a set of SIBs), one RACH preamble can be used to request multiple SI messages and the gNB acknowledges the request in MSG2. When MSG3 is used, the gNB acknowledges the request in MSG4.

The Other SI may be broadcast at a configurable periodicity and for a certain duration. It is a network decision whether the other SI is broadcast or delivered through dedicated and UE specific RRC signalling.

Each cell on which the UE is allowed to camp broadcasts at least some contents of the Minimum SI, while there may be cells in the system on which the UE cannot camp and do not broadcast the Minimum SI.

For a cell/frequency that is considered for camping by the UE, the UE is not required to acquire the contents of the minimum SI of that cell/frequency from another cell/frequency layer. This does not preclude the case that the UE applies stored SI from previously visited cell(s).

If the UE cannot determine the full contents of the minimum SI of a cell (by receiving from that cell or from valid stored SI from previous cells), the UE shall consider that cell as barred.

When multiple numerologies are mixed on a single carrier, only the default one is used for system information broadcast and paging.

3GPP R2-1710096 discusses how to resolve Msg3 based system information request procedure and how to design the system information request message used in the Msg3 based system information request procedure as follows:

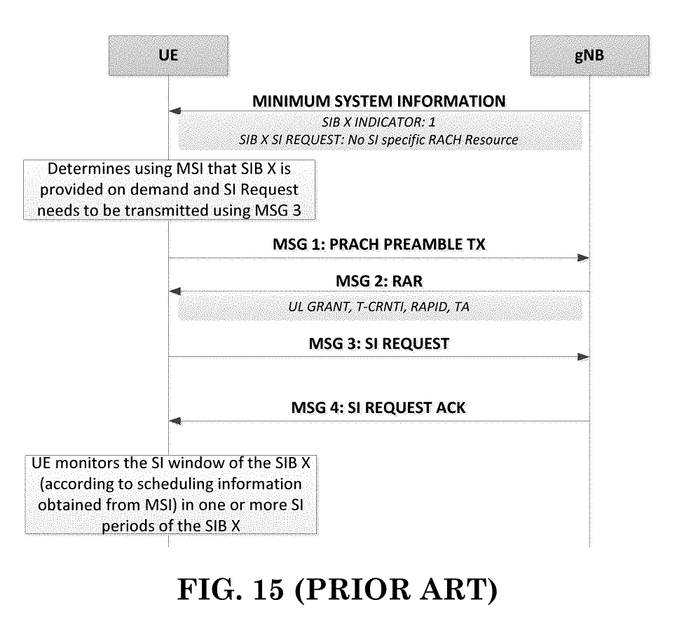

### MSG3/4 Contents

[FIG. 1 of 3GPP R2-1710096 is reproduced as FIG. 15]

FIG. 1 illustrates the operation for obtaining a SIB (e.g. SIB X) which is provided on demand (i.e. not broadcasted periodically) using the Msg3 based SI request.
1. After the successful reception of RAR, UE sends Msg3 in UL grant received in RAR. Msg3 includes CCCH SDU i.e. system information request message. System information request message is generated by RRC.
   The information about the SIB(s) needed by UE is included in system information request message.
   There is no need of any cause value in system information request message.
   There can be collision between UE1 transmitting SI request in Mgs3 and another UE2 transmitting other RRC message (such as connection request) in Msg3, if both UE1 and UE2 has transmitted Msg1 using same PRACH preamble/resource and has received the RAR. Msg3 from one of the UE may be successful. In the regular RA procedure, MAC CE carrying x bits (48 bits in LTE) of CCCH SDU transmitted in Msg3 is included in Msg4 so that UE can identify whether the Msg4 corresponds to its Msg3 transmission or not. Note that CCCH SDU is unique for a UE as it includes the UE identity. The similar approach can be followed for SI request i.e. UE identity can be included in system information request message. As a result same MAC CE can be used irrespective of whether SI request or other RRC control message (e.g. RRC connection request) was included in Msg3. Alternately, if UE identity is not included in system information request message then MAC needs to distinguish (either using a different MAC CE or some type field in MAC CE) whether the x bits of CCCH SDU included in Msg4 is related to SI request or not.
   Further, there is no need to optimize MSG3 used for RRC Connection Request, RRC Connection Resume and RRC Connection re-establishment to include SI request. If the UE intends to transition to connected state then the UE can make SI request through RRC signaling in connected state. There is no urgency identified to include SI request in RRC connection control messages.
Proposal 1: The information about the one or more SIB(s) needed by UE is included in SI request message.
Proposal 2: UE identity is included in SI request message.
Proposal 3: There is no need of any cause value in SI request message.
Proposal 4: There is no need to transmit SI request together with RRC connection control messages.
2. After sending SI request message, UE waits for Msg 4. UE starts contention resolution timer as in normal random access procedure.
   The Msg 4 should include the UE Contention Resolution Identity i.e. x bits of CCCH SDU transmitted in Msg 3.
   It was proposed in [2] to jointly acknowledge different SI requests from different UEs using a bitmap in single Msg 4. UE monitors Msg 4 in subframe relative to its SI request and the probability of several SI requests at same time as UE's request is very low. So we do not see gain in optimising the format for multiplexing acknowledgements for multiple SI requests in Msg 4.
3. After receiving the Msg 4 including the UE Contention Resolution Identity which matches the x bits of CCCH SDU transmitted in Msg 3, UE monitors the SI window of the requested SIB in one or more SI periods of the requested SIB.
4. In case of failure (i.e. contention resolution timer is expired) to receive the Msg 4, UE will retransmit the RACH preamble as in normal random access procedure.
Proposal 5: After sending SI request message, UE waits for Msg 4. UE starts contention resolution timer as in normal random access procedure.
Proposal 6: After receiving the Msg 4 including the UE Contention Resolution Identity which matches the x bits of CCCH SDU transmitted in Msg 3, UE monitors the SI window of the requested SIB in one or more SI periods of the requested SIB.
Proposal 7: In case of failure (i.e. expiry of contention resolution timer) to receive the Msg 4, UE will retransmit the RACH preamble as in normal random access procedure.

3GPP TS 36.331 captures the details of RRC behaviors and RRC parameters. More specifically, the detail of contention resolution identity, SRB 0˜3, UE state can be found in 3GPP TS 36.331 as follows:

### 4.2.2 Signalling Radio Bearers

“Signalling Radio Bearers” (SRBs) are defined as Radio Bearers (RB) that are used only for the transmission of RRC and NAS messages. More specifically, the following SRBs are defined:
SRB0 is for RRC messages using the CCCH logical channel;
SRB1 is for RRC messages (which may include a piggybacked NAS message) as well as for NAS messages prior to the establishment of SRB2, all using DCCH logical channel;
For NB-IoT, SRB1bis is for RRC messages (which may include a piggybacked NAS message) as well as for NAS messages prior to the activation of security, all using DCCH logical channel;
SRB2 is for RRC messages which include logged measurement information as well as for NAS messages, all using DCCH logical channel. SRB2 has a lower-priority than SRB1 and is always configured by E-UTRAN after security activation. SRB2 is not applicable for NB-IoT.

In downlink piggybacking of NAS messages is used only for one dependant (i.e. with joint success/failure) procedure: bearer establishment/modification/release. In uplink NAS message piggybacking is used only for transferring the initial NAS message during connection setup.
NOTE: The NAS messages transferred via SRB2 are also contained in RRC messages, which however do not include any RRC protocol control information.

Once security is activated, all RRC messages on SRB1 and SRB2, including those containing NAS or non-3GPP messages, are integrity protected and ciphered by PDCP. NAS independently applies integrity protection and ciphering to the NAS messages.

For a UE configured with DC, all RRC messages, regardless of the SRB used and both in downlink and uplink, are transferred via the MCG.

[ . . . ]

### 5.3.1.2 Security

AS security comprises of the integrity protection of RRC signalling (SRBs) as well as the ciphering of RRC signalling (SRBs) and user data (DRBs).

RRC handles the configuration of the security parameters which are part of the AS configuration: the integrity protection algorithm, the ciphering algorithm and two parameters, namely the keyChangeIndicator and the nextHopChainingCount, which are used by the UE to determine the AS security keys upon handover, connection re-establishment and/or connection resume.

The integrity protection algorithm is common for signalling radio bearers SRB1 and SRB2. The ciphering algorithm is common for all radio bearers (i.e. SRB1, SRB2 and DRBs). Neither integrity protection nor ciphering applies for SRB0.

[ . . . ]

### RRCConnectionRequest

The RRCConnectionRequest message is used to request the establishment of an RRC connection.
Signalling radio bearer: SRB0
RLC-SAP: TM
Logical channel: CCCH
Direction: UE to E-UTRAN

RRCConnectionRequest message

| | |
|---|---|
| -- ASN1START | |
| RRCConnectionRequest ::= | SEQUENCE { |
| criticalExtensions | CHOICE { |
| rrcConnectionRequest-r8 | RRCConnectionRequest-r8-IEs, |
| criticalExtensionsFuture | SEQUENCE { } |
| } | |
| } | |
| RRCConnectionRequest-r8-IEs ::= | SEQUENCE { |
| ue-Identity | InitialUE-Identity, |
| establishmentCause | EstablishmentCause, |
| spare | BIT STRING (SIZE (1)) |
| } | |
| InitialUE-Identity ::= | CHOICE { |
| s-TMSI | S-TMSI, |
| randomValue | BIT STRING (SIZE (40)) |
| } | |
| EstablishmentCause ::= | ENUMERATED { |
| | emergency, highPriorityAccess, mt-Access, mo-Signalling, |
| | mo-Data, delayTolerantAccess-v1020, mo-VoiceCall-v1280, |
| spare1} | |
| -- ASN1STOP | |

RRCConnectionRequest field descriptions

establishmentCause
Provides the establishment cause for the RRC connection request
as provided by the upper layers. W.r.t. the cause value names:
highPriorityAccess concerns AC11..AC15, ‘mt’ stands for
‘Mobile Terminating’ and ‘mo’ for ‘Mobile Originating.
eNB is not expected to reject a RRCConnectionRequest due to
unknown cause value being used by the UE.
randomValue
Integer value in the range 0 to 24⁴⁰-1.
ue-Identity
UE identity included to facilitate contention resolution by lower layers.

In NR, system information is divided into two general groups, minimum system information (minimum SI) and other system information (Other SI). In general, the minimum SI includes necessary information and/or parameters for the UE to perform initial access and to acquire any other SI broadcast. The system information excluding minimum SI belongs to Other SI. The Other SI could include sidelink related system information, V2X (Vehicle to Everything) related system information, MBMS (Multimedia Broadcast Multicast Services) system information, Mobility related information (e.g. cell and/or carrier and/or rat prioritization rule), etc.

For UE in RRC_CONNECTED, the UE will request the Other SI through dedicated RRC message(s), and will receive the Other SI also through dedicated RRC message(s). For UE in RRC_IDLE or RRC_INACTIVE, the UE could use Msg1 based system information request or Msg3 based system information request. The Msg3 based system information request procedure is to include a system information request message (SI request message) for indicating which system information being requested by the UE. Typically, the system information request message used in Msg3 based system information request will be the same (RRC) message used by the UE in RRC_CONNECTED state for requesting system information, because normally two different RRC messages are not defined for the same purpose.

Moreover, since the system information request message in Msg3 based SI request procedure is used by UEs in RRC_IDLE and UEs in RRC_INACTIVE, it is reasonable that the system information request message will be transmitted through SRB0. The reason is that SRBs other than SRB0 will need to use security protect. More specifically, the base station will need extra information and handshaking (optional) for understanding what security should be used for deciphering the system information request message if the system information request message is transmitted on SRBs other than SRB0.

Based on above discussion, the UE in RRC_CONNECTED state could perform system information request through transmitting the system information request message used in Msg3 based SI request procedure through SRB0. If a UE is configured with PUCCH resource for scheduling request (SR), the UE may trigger SR procedure due to data arrival. Based on the SR procedure, the UE can receive a dedicated uplink resource to perform a transmission including the system information request message. The base station will know what system information should be forwarded to the UE based on the system information request message.

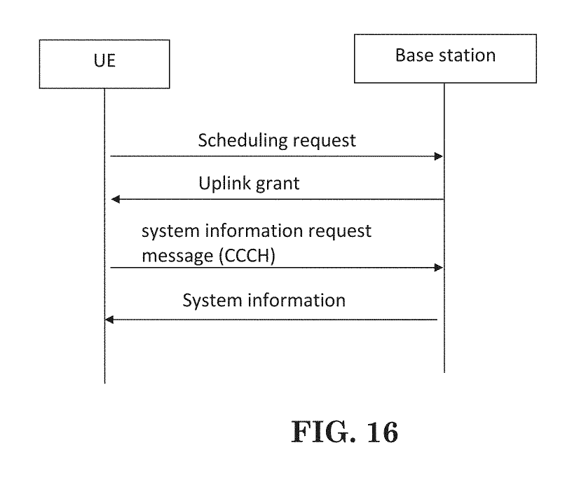

A possible example is shown in FIG. 16. In this example, the UE may trigger a SR due to uplink data arrival. After a base station receives the SR, the base station will allocate uplink resource to the UE (e.g. addressed to the UE's C-RNTI). The UE will use the uplink resource to transmit the system information request to the base station.

On the other hand, if UE has no PUCCH (Physical Uplink Control Channel) resource for scheduling request (SR), the UE will trigger a random access procedure for transmitting the system information request message. According to random access procedure, after a UE receives a Msg2 from base station, the UE will create a MAC (Medium Access Control) PDU (Protocol Data Unit) as Msg3 and transmit the MAC PDU based on uplink grant indicated in the Msg2. Based on current random access (RA) design, the UE will include the system information request message as MAC SDU (Service Data Unit) from CCCH (Common Control Channel) which is a logical channel associated with the SRB0. However, based on current RA design, the C-RNTI MAC CE is not allowed to be included into Msg3 if the Msg3 is going to include data from CCCH. In such case, although the system information request message will be transmitted to the base station, the base station cannot know which RRC_CONNECTED UE is requesting system information through this system information request message.

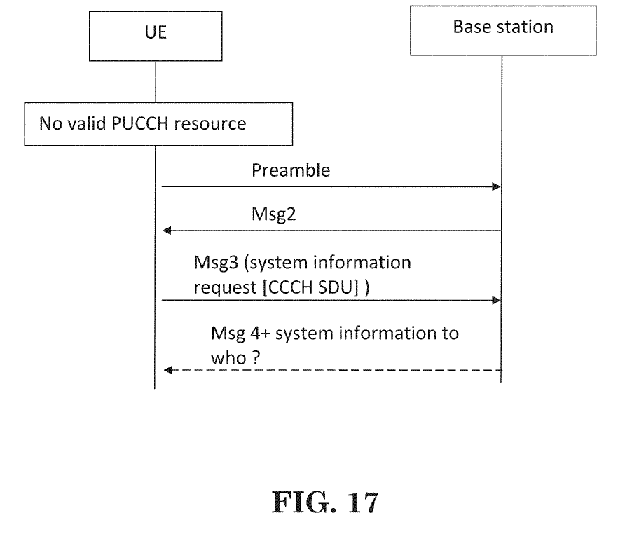

A possible example of the issue is shown in FIG. 17. One possible solution can be reusing contention resolution identity solution mentioned in 3GPP R2-1710096 for RRC_IDLE or RRC_INACTIVE. 3GPP R2-1710096 proposed to include a contention resolution identity into the system information request message which is similar to RRCConnectionRequest message. The base station could first resolve the contention and then forwarded the system information to the UE. However, some penalties exist in this solution. One possible penalty will be larger contention resolution identity. Larger contention resolution identity will take extra resource for transmission. Another possible penalty will be that the contention resolution identity in the system information request message is useless when the UE has PUCCH resource for scheduling request (SR). More specifically, the PUCCH resource for scheduling request (SR) can be used to reflect uplink resource need when data arrival in SRB (e.g. SRB0).

Below are some possible alternatives for the issue or possible enhancement for this solution.

I. Possible Enhancements for the Solution Mentioned Above:

Enhancement 1—

A UE includes a contention resolution identity into the system information request message when the UE requests system information in RRC_IDLE state and/or RRC_INACTIVE state (not in RRC_CONNECTED state). Furthermore, the UE includes C-RNTI (Information element) instead of the contention resolution identity in the system information request message when the UE is in RRC_CONNECTED state. Alternatively, the UE includes C-RNTI (Information element) instead of the contention resolution identity in the system information request message when the UE is in RRC_CONNECTED state and no PUCCH resource for transmitting scheduling request for data arrival in SRB0. The system information request message is transmitted through a random access procedure. Moreover, the UE will need to modify or to add new judgement for contention resolution for this enhancement. The UE will consider the contention being resolved when receiving a PDCCH transmission addressed to the UE's C-RNTI, even if a CCCH SDU was included in Msg3. The PDCCH transmission could be an uplink grant. The PDCCH transmission could be a downlink assignment.

Alternatively, even if a CCCH SDU was included in Msg3, the UE will need to consider the contention being resolved when receiving a downlink assignment based on the UE's C-RNTI and the DL assignment includes one or more following information:
1. System information requested by the UE (partially or completely)
2. Confirmation for reception of the system information request

Nevertheless, the new judgement could also be used in a case that the UE is in RRC_CONNECTED state and transmitted a system information request message with contention resolution identity. More specifically, after the UE is in RRC_CONNECTED state and transmits a system information request message with contention resolution identity, the UE can resolve the random access by receiving a downlink assignment with contention resolution MAC CE for the contention resolution identity or by receiving a PDCCH addressed its valid C-RNTI. The PDCCH transmission could be an uplink grant. The PDCCH transmission could be a downlink assignment.

Alternatively, the UE will need to consider the contention being resolved when receiving a downlink assignment with contention resolution MAC CE for the contention resolution identity or when receiving a downlink assignment based on the UE's C-RNTI and the DL assignment includes one or more following information:
1. System information requested by the UE (partially or completely)
2. Confirmation for reception of the system information request

Enhancement 2—

A UE includes a contention resolution identity into the system information request message when the UE requests system information in RRC_IDLE state and/or RRC_INACTIVE state (not in RRC_CONNECTED state). The UE will not include the contention resolution identity into the system information request message if the UE is configured with valid PUCCH resource for transmitting scheduling request for data arrival in SRB0.

Enhancement 3—

A UE includes a contention resolution identity into the system information request message when the UE requests system information in RRC_IDLE state and/or RRC_INACTIVE state (not in RRC_CONNECTED state). Moreover, if the UE in RRC_CONNECTED transmits the system information request message including the contention resolution identity through a contention based random access procedure, the UE will not replace its C-RNTI by the Temporary C-RNTI used in Msg3 transmission when the contention is resolved.

Enhancement 4—

A UE could trigger a scheduling request for SRB0. Currently, the network could not reconfigure SRB0 and SRB0 will not associate with SR configuration. Hence, the SR procedure mentioned above will be triggered by other uplink data. And the dedicated resource will be used for transmitting the system information request message based on LCP procedure. To enhance system information request procedure, the CCCH or SRB0 could be associated with one or multiple SR configurations or could use/trigger scheduling request based on one or multiple SR configurations. FIG. 16 illustrates an example with the enhancement applied. In this example, the UE will trigger a SR due to uplink data arrival in SRB0. After a base station receives the SR, the base station will allocate uplink resource to the UE (e.g. addressed to the UE's C-RNTI). The UE will use the uplink resource to transmit the system information request to the base station.

In one embodiment, the SRB0 or the CCCH is associated with one or multiple SR configurations through a RRC message (e.g. RRC reconfiguration message). In another embodiment, the SRB0 or the CCCH is associated with one or multiple SR configurations based on a default configuration. The default configuration could include SR configuration index(es). In another embodiment, the SRB0 or the CCCH is associated with one or multiple SR configurations based on predefined rule. For example, the data arrival of the SRB0 (or the CCCH) could trigger scheduling request based on any one of available SR configuration. As another example, the data arrival of the SRB0 (or the CCCH) could trigger scheduling request based on all available SR configurations. As another example, the data arrival of the SRB0 (or the CCCH) could trigger scheduling request based on an available SR configuration having a SR transmission opportunity closest to and after the timing of system information request being triggered.

II. Other Solutions for the Same Issue:

Solution 1: Include Both SI Request Message (i.e. CCCH SDU) and C-RNTI MAC CE in MAC PDU for Msg3 Transmission

One possible way is that, the MAC entity includes both SI request message (a CCCH SDU generated by upper layer) and C-RNTI (a MAC CE generated by MAC itself) in the MAC PDU for Msg3 transmission, based on one or some of the following conditions:
1. If MAC entity recognizes whether the CCCH SDU is for SI request
2. If UE/MAC entity has a valid C-RNTI
3. If the size of CCCH SDU is below a threshold (or not above a threshold) and/or above a another threshold or equal to a specific size.

For this solution, the MAC entity should determine whether it needs to additionally include a C-RNTI MAC CE in the MAC PDU including CCCH SDU(s). For Condition 1, the MAC entity knows whether the CCCH SDU is for SI request or not either by itself (e.g. an indication in the CCCH SDU or a special logical channel (LCID) used by the CCCH SDU) or indicated by upper layer (e.g. RRC). If the CCCH SDU is for SI request, the UE will include C-RNTI MAC CE. Otherwise, the UE would not include C-RNTI when a MAC PDU is for CCCH SDU.

For Condition 2, the MAC entity always tries to include a C-RNTI MAC CE in the MAC PDU for Msg3 transmission when the MAC entity or UE has valid C-RNTI, regardless of the presence or absence of the CCCH SDU. In one embodiment, after the UE performs MAC reset to a MAC entity, the valid C-RNTI in the MAC entity will be clear. As a result, when performing logical prioritization for Msg3 transmission, the priority of CCCH and the priority of C-RNTI should be defined, since both of them has same and highest priority in LTE.

In one alternative, the priority of CCCH should be higher than C-RNTI MAC CE to ensure that CCCH SDU not for SI request could be included before C-RNTI MAC CE. After completing the RA procedure, the MAC entity can optionally discard the C-RNTI MAC CE if it is not needed. In another alternative, the priority of CCCH should be lower than C-RNTI MAC CE to ensure that C-RNTI MAC CE could be included. Based on the C-RNTI MAC CE, network could further schedule uplink resource to the UE for guaranteeing SI request message (CCCH SDU) transmission. In such case, the SRB0 should be linked to at least a SR configuration and/or a LCG.

For Condition 3, the threshold is to identify the SI request message (CCCH SDU) from all possible RRC messages transmitted through CCCH. It would be better that the minimum size of UL grant provided by NW for Msg3 transmission is equal or larger than the size of CCCH SDU for SI request plus the size of C-RNTI MAC CE.

In this solution, the contention could be resolved by a PDCCH transmission addressed to the UE's or the MAC entity's C-RNTI. The PDCCH transmission could be a downlink assignment. The PDCCH could be an uplink grant. The contention could be resolved by a downlink transmission including at least one or multiple information listed below:
1. System information requested by the UE (partially or completely)
2. Confirmation for reception of the system information request

Solution 2: The CCCH SDU for SI Request Already Contains a C-RNTI Information Element

For this solution, the MAC entity does not need to determine whether it needs to additionally include a C-RNTI MAC CE in the MAC PDU or not. Because Msg3-based SI request is also applicable for RRC-idle UE which does not have a valid C-RNTI, the C-RNTI information element in the CCCH SDU should be an optional field for this solution. RRC layer is thus responsible for determine whether a C-RNTI should be included in the CCCH SDU for SI request (SI request message) or not. In one embodiment, if UE does not include C-RNTI information element into the SI request message, then the UE will include a contention resolution identity (e.g. S-TMSI or random number) into the SI request message. In one embodiment, the RRC decides to include C-RNTI information element into the SI request message, when UE is in RRC_CONNECTED state.

In this solution, the contention could be resolved by a PDCCH transmission addressed to the UE's or the MAC entity's C-RNTI. The PDCCH transmission could be a downlink assignment. The PDCCH could be an uplink grant. The contention could be resolved by a downlink transmission including at least one or multiple information listed below:
1. System information requested by the UE (partially or completely)
2. Confirmation for reception of the system information request

Solution 3: SI Request Message is Transmitted on a Logical Channel (e.g. DCCH) Different from CCCH for RRC-Connected-Mode UE

Another solution is that SI request message is transmitted on CCCH while UE is in RRC idle and/or RRC inactive mode, and is transmitted on a logical channel or a radio bearer (e.g. DCCH, DRB, SRB1, SRB2 and/or SRB3) different from CCCH or SRB0 while UE is in RRC connected mode. For SI request message transmitted on the logical channel or a radio bearer different from CCCH or SRB0, since CCCH SDU and C-RNTI MAC CE will not be included in the MAC PDU at the same time, the UE could reuse current LTE 4-step RA procedure (i.e. if the transmission is not being made for the CCCH logical channel, indicate to the Multiplexing and assembly entity to include a C-RNTI MAC control element in the subsequent uplink transmission). At the same time, a SI request message transmitted by a UE in RRC idle and/or RRC inactive mode may include a contention resolution identity, while another SI request message transmitted by a UE in RRC_CONNECTED mode will not include the contention resolution identity.

In this solution, the contention could be resolved by a PDCCH transmission addressed to the UE's or the MAC entity's C-RNTI. The PDCCH transmission could be a downlink assignment. The PDCCH could be an uplink grant. The contention could be resolved by a downlink transmission including at least one or multiple information listed below:
1. System information requested by the UE (partially or completely)
2. Confirmation for reception of the system information request

After transmitting the SI request through Msg3, the UE will consider Contention Resolution successful and Random Access procedure successfully completed if it receives a PDCCH addressed to its C-RNTI. Preferably, the PDCCH is a DL assignment. In one embodiment, the DL assignment contains system information requested by the UE. In one embodiment, the DL assignment contains confirmation from NW for reception of the UE's SI request.

For Solution 2, even though there is no C-RNTI MAC CE included in Msg3, the UE can still consider Contention Resolution successful and Random Access procedure successfully completed if it receives a PDCCH addressed to its C-RNTI. In LTE, when CCCH SDU instead of C-RNTI MAC CE is included in the Msg3, the UE considers Contention Resolution successful and Random Access procedure successfully completed if it receives a DL assignment and the received MAC PDU contains a UE Contention Resolution Identity MAC CE matching the first 48 bits of the CCCH SDU transmitted in Msg3.

The contention resolution identity could be a random value or could include a random value (e.g. >=40 bits or >=S-TMSI length). The contention resolution identity could be a S-TMSI or could include a S-TMSI.

In one embodiment, the above discussion is focusing on same scheduler condition (e.g. same base station, same cell, same TRP, same DU. Network in this discussion could mean a base station, a TRP, a CU, a DU, a network node, or a scheduler, vice versa.

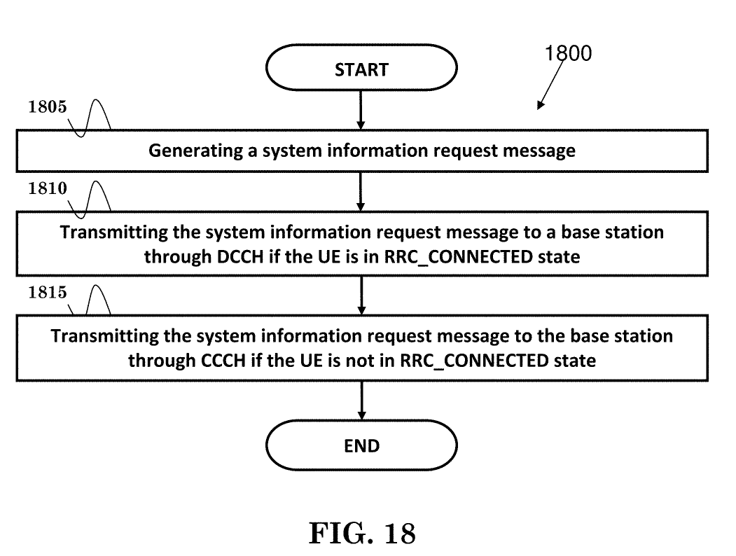

FIG. 18 is a flow chart 1800 according to one exemplary embodiment from the perspective of a UE. In step 1805, the UE generates a system information request message. In step 1810, the UE transmits the system information request message to a base station through DCCH if the UE is in RRC_CONNECTED state. In step 1815, the UE transmits the system information request message to the base station through CCCH if the UE is not in RRC_CONNECTED state.

In one embodiment, the UE could receive a system information from the base station through a dedicated message after the UE transmits the system information request message. In one embodiment, the UE is not in RRC_CONNECTED could mean that the UE is in RRC_IDLE state or RRC_INACTIVE state.

Referring back to FIGS. 3 and 4, in one exemplary embodiment of a UE for performing a random access procedure, the device 300 includes a program code 312 stored in the memory 310. The CPU 308 could execute program code 312 to enable the UE (i) to generate a system information request message, (ii) to transmit the system information request message to a base station through DCCH if the UE is in RRC_CONNECTED state, and (iii) to transmit the system information request message to the base station through CCCH if the UE is not in RRC_CONNECTED state. Furthermore, the CPU 308 can execute the program code 312 to perform all of the above-described actions and steps or others described herein.

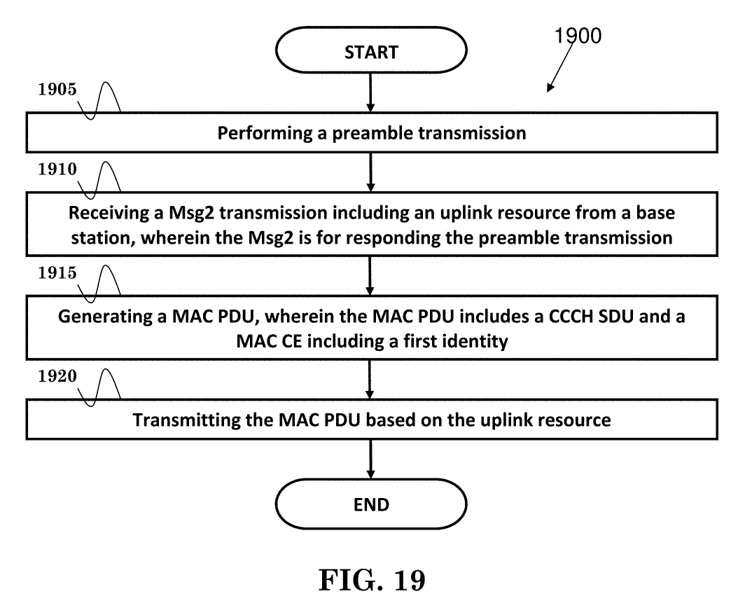

FIG. 19 is a flow chart 1900 according to one exemplary embodiment from the perspective of a UE. In step 1905, the UE performs a preamble transmission. In step 1910, the UE receives a Msg2 transmission including an uplink resource from a base station, wherein the Msg2 is for responding the preamble transmission. In step 1915, the UE generates a MAC PDU, wherein the MAC PDU includes a CCCH SDU and a MAC CE including a first identity. In step 1920, the UE transmits the MAC PDU based on the uplink resource.

In one embodiment, the UE could determine to include both the CCCH SDU and the MAC CE if the CCCH SDU is used to request system information. In another embodiment, the UE could determine to include the CCCH SDU but not including the MAC CE if the CCCH SDU is not used to request system information. Alternatively, the UE could determine to include both the CCCH SDU and the MAC CE if the UE has a valid identity for the MAC CE. In another embodiment, the UE could determine to include the CCCH SDU but not including the MAC CE if the UE has no valid identity for the MAC CE.

In the above embodiments, the uplink resource could accommodate the MAC CE and the CCCH SDU. Furthermore, the UE could determine to include both the CCCH SDU and the MAC CE based on whether the size of the CCCH SDU is over or below a threshold.

In one embodiment, the MAC CE could be a C-RNTI (Cell-Radio Network Temporary Identifier) MAC CE. The CCCH SDU could be a system information request message.

In one embodiment, the UE could determine the random access procedure is successful completed if the UE receives a downlink control signal addressed to the first identity after transmitting the MAC PDU. The downlink control signal could indicate an uplink resource or a downlink transmission. Alternatively, the UE could determine the random access procedure is successful completed if the UE receives a system information requested in the CCCH SDU after transmitting the MAC PDU.

In one embodiment, the UE could be in RRC_CONNECTED state. In one embodiment, the CCCH SDU may not contain a second identity.

In one embodiment, the UE may not generate the MAC PDU containing both the CCCH SDU and the MAC CE, when the UE is in RRC_IDLE state and/or RRC_INACTIVE state. However, the UE could generate the MAC PDU containing the CCCH SDU and without the MAC CE, when the UE is in RRC_IDLE state and/or RRC_INACTIVE state.

Referring back to FIGS. 3 and 4, in one exemplary embodiment of a UE, the device 300 includes a program code 312 stored in the memory 310. The CPU 308 could execute program code 312 to enable the UE (i) to perform a preamble transmission, (ii) to receive a Msg2 transmission including an uplink resource from a base station, wherein the Msg2 is for responding the preamble transmission, (iii) to generate a MAC PDU, wherein the MAC PDU includes a CCCH SDU and a MAC CE including a first identity, and (iv) to transmit the MAC PDU based on the uplink resource. Furthermore, the CPU 308 can execute the program code 312 to perform all of the above-described actions and steps or others described herein.

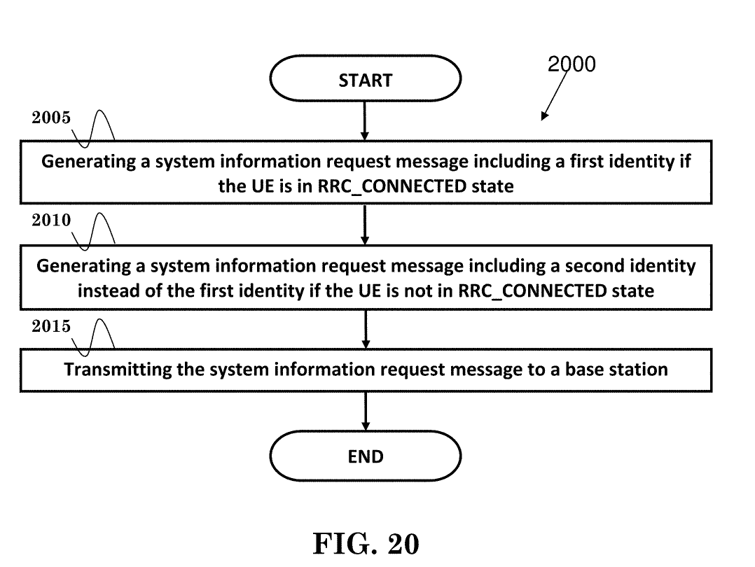

FIG. 20 is a flow chart 2000 according to one exemplary embodiment from the perspective of a UE. In step 2005, the UE generates a system information request message including a first identity if the UE is in RRC_CONNECTED state. In step 2010, the UE generates a system information request message including a second identity instead of the first identity if the UE is not in RRC_CONNECTED state. In step 2015, the UE transmits the system information request message to a base station.

In one embodiment, the system information request message could be a RRC (Radio Resource Control) message. In one embodiment, the system information request message could be transmitted through SRB0 and/or CCCH.

In one embodiment, the UE could receive a system information from the base station through a dedicated message after the UE transmits the system information request message. The system information message may not include the second identity when the UE transmits the system information message in RRC_CONNECTED. The first identity could be a C-RNTI or an identity used for scheduling resource. The second identity could be a contention resolution identity, a S-TMSI, or a random value. The first identity could be shorter than the second identity. The second identity could be equal to or larger than 40 bits.

Referring back to FIGS. 3 and 4, in one exemplary embodiment of a UE, the device 300 includes a program code 312 stored in the memory 310. The CPU 308 could execute program code 312 to enable the UE (i) to generate a system information request message including a first identity if the UE is in RRC_CONNECTED state, (ii) to generate a system information request message including a second identity instead of the first identity if the UE is not in RRC_CONNECTED state, and (iii) to transmit the system information request message to a base station. Furthermore, the CPU 308 can execute the program code 312 to perform all of the above-described actions and steps or others described herein.

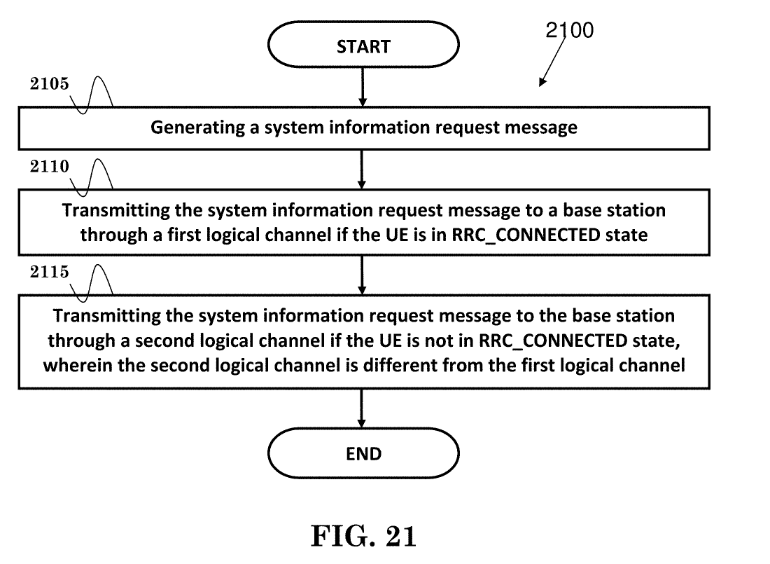

FIG. 21 is a flow chart 2100 according to one exemplary embodiment from the perspective of a UE. In step 2105, the UE generates a system information request message. In one embodiment, the system information request message could be a RRC message.

In step 2110, the UE transmits the system information request message to a base station through a first logical channel if the UE is in RRC_CONNECTED state. In step 2115, the UE transmits the system information request message to the base station through a second logical channel if the UE is not in RRC_CONNECTED state, wherein the second logical channel is different from the first logical channel.

In one embodiment, the UE could receive a system information from the base station through a dedicated message after the UE transmits the system information request message. The first logical channel could be DCCH, and could be linked to SRB1, SRB2, or SRB3. The second logical channel could be CCCH, and could be linked to SRB0.

Referring back to FIGS. 3 and 4, in one exemplary embodiment of a UE, the device 300 includes a program code 312 stored in the memory 310. The CPU 308 could execute program code 312 to enable the UE (i) to generate a system information request message, (ii) to transmit the system information request message to a base station through a first logical channel if the UE is in RRC_CONNECTED state, and (iii) to transmit the system information request message to the base station through a second logical channel if the UE is not in RRC_CONNECTED state, wherein the second logical channel is different from the first logical channel. Furthermore, the CPU 308 can execute the program code 312 to perform all of the above-described actions and steps or others described herein.

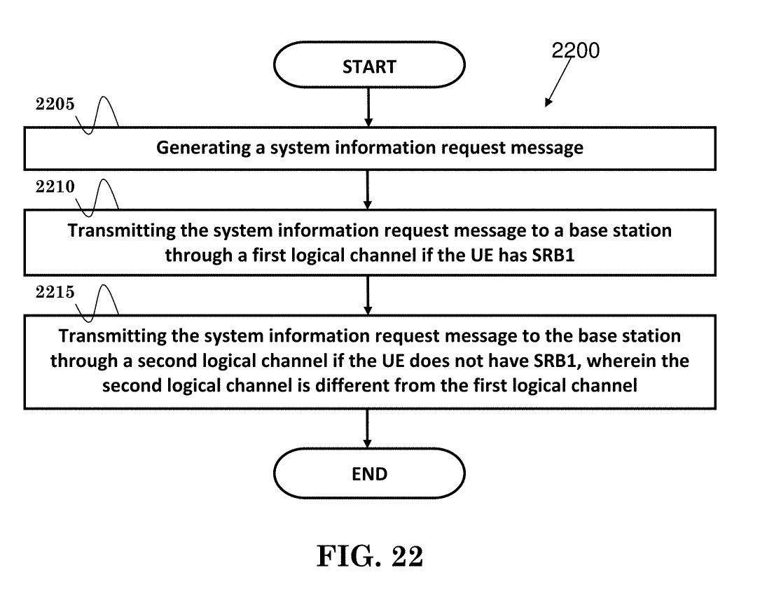

FIG. 22 is a flow chart 2200 according to one exemplary embodiment from the perspective of a UE. In step 2205, the UE generates a system information request message. In step 2210, the UE transmits the system information request message to a base station through a first logical channel if the UE has SRB1. In step 2215, the UE transmits the system information request message to the base station through a second logical channel if the UE does not have SRB1, wherein the second logical channel is different from the first logical channel.

In one embodiment, the first logical channel could be DCCH. The second logical channel could be CCCH.

In one embodiment, the UE may have no SRB1 if the SRB1 is suspended. Alternatively, the UE may have SRB1 even if the SRB1 is suspended.

In one embodiment, the system information request message transmitted on the first logical channel may contain no UE identity. The system information request message transmitted on the second logical channel may contain a UE identity.

Referring back to FIGS. 3 and 4, in one exemplary embodiment of a UE, the device 300 includes a program code 312 stored in the memory 310. The CPU 308 could execute program code 312 to enable the UE (i) to generate a system information request message, (ii) to transmit the system information request message to a base station through a first logical channel if the UE has SRB1, and (iii) to transmit the system information request message to the base station through a second logical channel if the UE does not have SRB1, wherein the second logical channel is different from the first logical channel. Furthermore, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a UE (User Equipment), comprising:
generating a system information request message;
transmitting the system information request message to a base station through DCCH (Dedicated Control Channel) if the UE is in RRC_CONNECTED state; and
transmitting the system information request message to the base station through CCCH (Common Control Channel) if the UE is not in RRC_CONNECTED state.

2. The method of claim 1, further comprising:
the UE receives a system information from the base station through a dedicated message after the UE transmits the system information request message.

3. The method of claim 1, wherein the UE is not in RRC_CONNECTED means that the UE is in RRC_IDLE state or RRC_INACTIVE state.

4. A method for a UE (User Equipment), comprising:
performing a preamble transmission;
receiving a Msg2 transmission including an uplink resource from a base station, wherein the Msg2 is for responding the preamble transmission;
generating a MAC (Medium Access Control) PDU (Protocol Data Unit), wherein the MAC PDU includes a CCCH (Common Control Channel) SDU (Service Data Unit) and a MAC CE (Control Element) including a first identity; and
transmitting the MAC PDU based on the uplink resource.

5. The method of claim 4, further comprising:
the UE determines to include both the CCCH SDU and the MAC CE if the CCCH SDU is used to request system information.

6. The method of claim 4, further comprising:
the UE determines to include both the CCCH SDU and the MAC CE if the UE has a valid identity for the MAC CE.

7. The method of claim 4, wherein the MAC CE is a C-RNTI (Cell-Radio Network Temporary Identifier) MAC CE.

8. The method of claim 4, wherein the CCCH SDU is a system information request message.

9. The method of claim 4, further comprising:
the UE determines the random access procedure is successful completed if the UE receives a downlink control signal addressed to the first identity after transmitting the MAC PDU.

10. The method of claim 4, further comprising:
the UE determines the random access procedure is successful finished if the UE receives a system information requested in the CCCH SDU after transmitting the MAC PDU.

11. A User Equipment (UE), comprising:
a control circuit;
a processor installed in the control circuit; and
a memory installed in the control circuit and operatively coupled to the processor;
wherein the processor is configured to execute a program code stored in the memory to:
generate a system information request message; and
transmit the system information request message to a base station through DCCH (Dedicated Control Channel) if the UE is in RRC_CONNECTED state; and
transmit the system information request message to the base station through CCCH (Common Control Channel) if the UE is not in RRC_CONNECTED state.

12. The UE of claim 11, wherein the processor is further configured to execute a program code stored in the memory to:
receive a system information from the base station through a dedicated message after the UE transmits the system information request message, if the UE is in RRC_CONNECTED state.

13. The UE of claim 11, wherein the UE is not in RRC_CONNECTED means that the UE is in RRC_IDLE state or RRC_INACTIVE state.

14. A User Equipment (UE), comprising:
a control circuit;
a processor installed in the control circuit; and
a memory installed in the control circuit and operatively coupled to the processor;
wherein the processor is configured to execute a program code stored in the memory to:
perform a preamble transmission;
receive a Msg2 transmission including an uplink resource from a base station, wherein the Msg2 is for responding the preamble transmission;
generate a MAC (Medium Access Control) PDU (Protocol Data Unit), wherein the MAC PDU includes a CCCH (Common Control Channel) SDU (Service Data Unit) and a MAC CE (Control Element) including a first identity; and
transmit the MAC PDU based on the uplink resource.

15. The UE of claim 14, wherein the processor is further configured to execute a program code stored in the memory to:
determine to include both the CCCH SDU and the MAC CE if the CCCH SDU is used to request system information.

16. The UE of claim 14, wherein the processor is further configured to execute a program code stored in the memory to:
determine to include both the CCCH SDU and the MAC CE if the UE has a valid identity for the MAC CE.

17. The UE of claim 14, wherein the MAC CE is a C-RNTI (Cell-Radio Network Temporary Identifier) MAC CE.

18. The UE of claim 14, wherein the CCCH SDU is a system information request message.

19. The UE of claim 14, wherein the processor is further configured to execute a program code stored in the memory to:
determine the random access procedure is successful finished if the UE receives a downlink control signal addressed to the first identity after transmitting the MAC PDU.

20. The UE of claim 14, wherein the processor is further configured to execute a program code stored in the memory to:
determine the random access procedure is successful completed if the UE receives a system information requested in the CCCH SDU after transmitting the MAC PDU.
